(19) United States
(12) Patent Application Publication
(10) Pub. No.: US 2008/0041946 A1
(43) Pub. Date: Feb. 21, 2008

(54) Commodity Management System and Mobile Commodity Case

(76) Inventors: Keiji Matsumoto, Kyoto (JP); Atsunori Shinoda, Kyoto (JP)

Correspondence Address: DICKSTEIN SHAPIRO LLP, 1825 EYE STREET NW, Washington, DC, 20006-5403, US

(21) Appl. No.: 10/585,370

(22) PCT Filed: Jan. 14, 2005
(86) PCT No.: PCT/JP05/00385

§ 371 Date: Apr. 9, 2007

(30) Foreign Application Priority Data
Jan. 14, 2004 (JP) 2004-006180

(51) Int. Cl. G06F 19/00

(52) U.S. Cl. 235/385

(57) ABSTRACT

A commodity management system includes: a mobile commodity case (12) storing a plurality of commodities each having an information storage medium which allows information to be read out or written in between a reader/writer (13) and the information storage medium in a contact-less manner; and control means for gathering information on all the commodities stored in the mobile commodity case (12) en bloc via contact-less communications with the information storage media and the reader/writer (13).

### TECHNICAL FIELD

The present invention relates to a stock management system for managing a stock of commodities such as jewelries, noble metal, glasses, high class watches, or the like. More specifically, the present invention relates to an efficient commodity management system and a mobile commodity case which allow stock information of plural commodities to be gathered en bloc in a contact-less manner.

### BACKGROUND ART

An antenna of a reader/writer and an RFID tag (Radio Frequency Identification Tag; hereinafter, RF tag) have conventionally been transmitting/receiving information therebetween, by using communications method disclosed in, for example, Japanese Unexamined Patent Publication No. 336071/1998 (Tokukaihei 10-336071; published on Dec. 18, 1998).

Typically, in the communications method, a transmitter signal generated by modulating a carrier wave of a predetermined frequency is transmitted from the antenna of the reader/writer to the RF tag. On the other hand, based on the signal having been transmitted from the antenna of the reader/writer, the RF tag performs reading/writing of information, and receives a power supply.

Incidentally, communications is performed by using so-called load-switching method in which, in response to the signal from the antenna of the reader/writer, a load impedance of the antenna of the RF tag is varied, according to information having been read out, so that an intended information is transmitted from the RF tag to the antenna of the reader/writer.

In this way, contact-less communications is performed between the antenna of the reader/writer and the RF tag, and the reader/writer gathers necessary information from the RF tag, via the antenna. For example, the RF tag is attached to each of commodities such as jewelry goods, and a large number of such commodities having the RF tag are exhibited in a show-case. In such a case, if a customer asks for a stock of a specific commodity, the seller is able to use the reader/writer to read information regarding where in the show-case the requested specific commodity is located, so as to promptly recognize the position of the commodity, and take it out for the customer.

Further, Japanese Unexamined Patent Publication No. 334157/1998 (Tokukaihei 10-334157; published on Dec. 18, 1998) discloses a commodity-sales analyzing system which allows a sales analysis of well-selling-commodities based on sales data of sold commodities and commodity stock data, with the use of a reader/writer for reading in a contact-less manner an RF tag attached to each commodity.

For example, such a commodity sales analysis or stock management may be as follows. Namely, as illustrated in FIG. 8, in a show-case 81, an antenna of the reader/writer 84 is laid down, in a plane manner, on the entire bottom surface of a exhibition surface 83 on which commodities 82 such as jewelry goods are placed for displaying. Further, above this antenna 84, contact-less communications is performed with an RF tag 85 attached to each of the commodity 82, so that information of the commodities in the show-case 81 is gathered en bloc. Then, the gathered commodity information is analyzed in a personal computer 86 for the purpose of sales promotion.

On the other hand, the commodities outside a shop (instead of the ones inside the shop) are managed as follows. Namely, in the management of the commodity outside the shop, a salesperson, who takes out expensive commodities 91 (e.g. jewelry) from the shop and visits customers to sell the commodities 91, carries a large number of the commodities 91 in a business case 92 during his/her sales activity, as illustrated in FIG. 9. Prior to such sales activity outside the shop, the sales person uses, in the shop, a barcode reader (handy scanner) 95 to read one by one respective barcodes 94 on price tags attached to the commodities 91 stored in the business bag 92. Then, the sales person starts his/her sales activity, after a record of commodities to be taken out is made by reading the barcodes 94 of all the commodities.

On the other hand, when the sales person returns to the shop from his/her sales activity, he/she uses the barcode reader 95 to read one by one the respective barcodes 94 on the price tags of the commodities 91 remaining in the business case 92. Here, a difference in the number of barcodes having been read before and after the sales activity is the number of commodities sold, and the number of the commodities remaining in the business case 92 is managed as stock data.

When managing commodities during a sales activity in which commodities inside a shop are taken out outside the shop as described above, an accurate management of all commodities is necessary before and after the sales activity. Checking of commodities is particularly important, in a case where the commodities are expensive jewelry goods or the like.

However, in such a commodity stock management system, the salesperson has to spend more effort in reading the barcodes, proportionally to the number of commodities to be taken outside the shop at the time of sales activity. This is more troublesome and time-consuming, and heavily burdens the salesperson.

### DISCLOSURE OF INVENTION

In order to solve the foregoing problem, it is an object of the present invention to provide a commodity management system and a mobile commodity case, for realizing an efficient stock management, on the occasion where commodities are taken outside a shop for a sales activity.

In order to achieve the foregoing object, a commodity management system of the present invention includes: a mobile commodity case for storing a plurality of commodities each having information storage medium which is writable and readable so that writing and reading out of information in a contact-less manner are possible between a reader/writer and the information storage medium; and control means for collecting en bloc information of all the commodities stored in the mobile commodity case, via contact-less communications performed between the information storage mediums and the reader/writer.

With the configuration, the information regarding a large number of commodities stored in the mobile commodity case is read out en bloc by contact-less communications with the reader/writer. Accordingly, a salesperson is able to efficiently perform commodity stock management in a short time.

For example, in a case where a sales activity is conducted, carrying commodities in a shop in the mobile commodity case, the information of the commodities is gathered by using the reader/writer, without a need for opening the mobile commodity case before and after the sales activity. This allows for an efficient stock management.

Further, in order to achieve the foregoing object, a mobile commodity case of the present invention includes: a reader/writer; storing means for storing a plurality of commodities each having information storage medium which is writable and readable so that writing and reading out of information in a contact-less manner are possible between a reader/writer and the information storage medium; and control means for performing contact-less communications between the reader/writer and the information storage medium, so as to collect en bloc information of all the commodities stored in the storing means.

In the above configuration, the information of the commodities in stored in the storing means is gathered en bloc by using the reader/writer. Therefore, it is possible to accurately manage the information regarding commodities with the use of the mobile commodity case only.

Accordingly, the stock management of the commodities is more efficiently carried out by using the above mobile commodity case at the time of conducting a sales activity by taking out the commodities from the shop.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a diagram of an embodiment in accordance with the present invention, and is illustrating a configuration of a stock management system prior to a sales activity.

FIG. 2 is a perspective view illustrating a number of jewelry goods stored in the case illustrated in FIG. 1.

FIG. 3 is a block diagram illustrating a configuration of the reader/writer illustrated in FIG. 1.

FIG. 4 is a diagram illustrating the jewelry goods illustrated in FIG. 2, and price tags provided with RF tags.

FIG. 5 is a block diagram illustrating a configuration of the RF tags attached to the jewelry goods illustrated in FIG. 2.

FIG. 6 is a diagram illustrating the stock management system illustrated in FIG. 1, after the sales activity.

FIG. 7 is a perspective view of another embodiment in accordance with the present invention, and is illustrating a configuration of a stock management case.

FIG. 8 is a diagram illustrating a configuration of a conventional stock management system for jewelry goods.

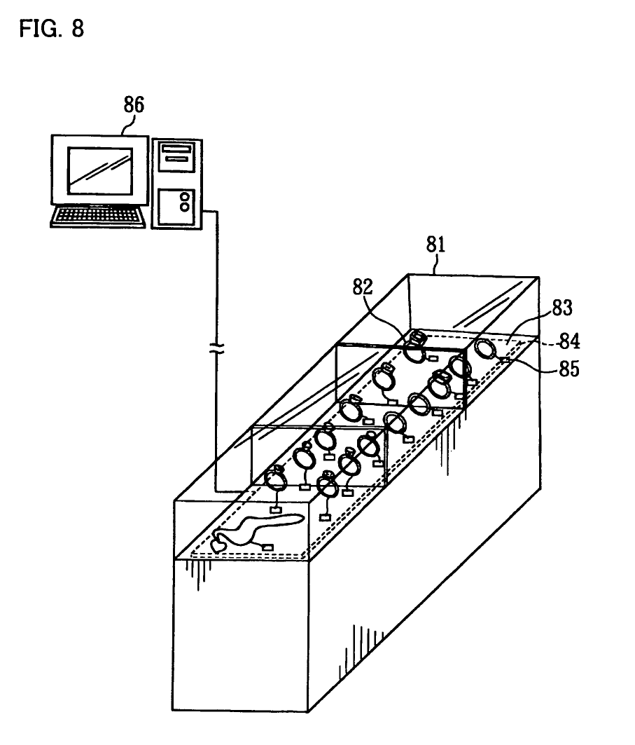

FIG. 9 is a diagram illustrating stock management work for jewelry goods, by using conventional barcodes.

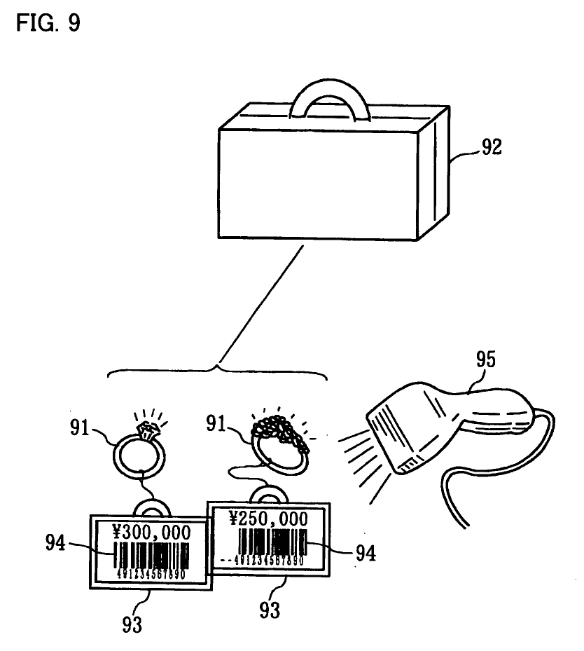

### BEST MODE FOR CARRYING OUT THE INVENTION

The present invention is for establishing communications means which is capable of gathering en bloc and in a contact-less manner, information of each commodity in a mobile case, which information is associated with an RF tag of the commodity. Described hereinbelow are specific embodiments of the present invention.

### Embodiment 1

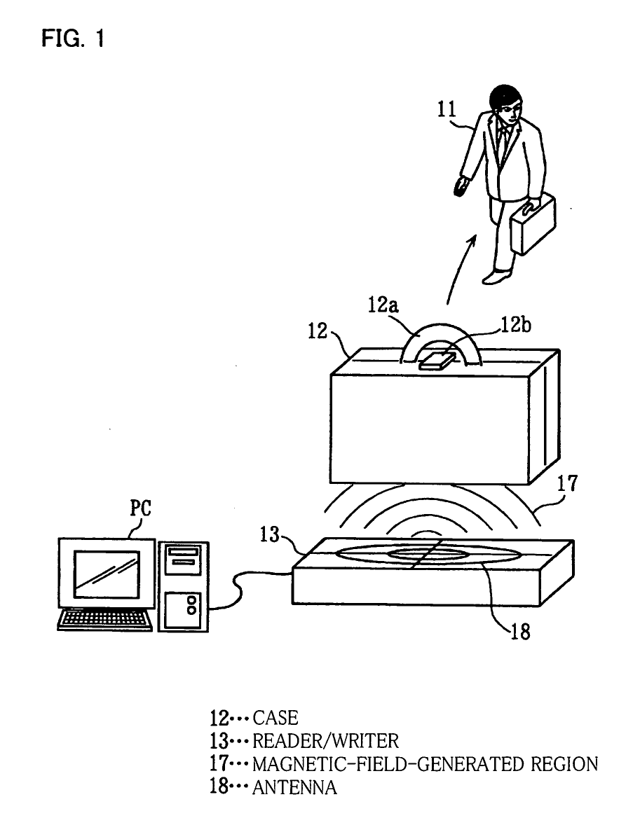

The following describes, with reference to drawings, an embodiment of the present invention. As illustrated in FIG. 1, a commodity management system of the embodiment according to the present invention is for managing stocks of jewelry goods with a use of a mobile case. This commodity management system includes: a mobile commodity case 12 to be disposed by a salesperson 11, and a personal computer PC connected to a contact-less communications-use reader/writer 13.

The commodity case 12 has therein a storage space for jewelry goods (i.e. commodities) 14. One side of the commodity case 12 is configured so as to open or close. Furthermore, outside the commodity case 12, a grip 12a and a locking device 12b are provided.

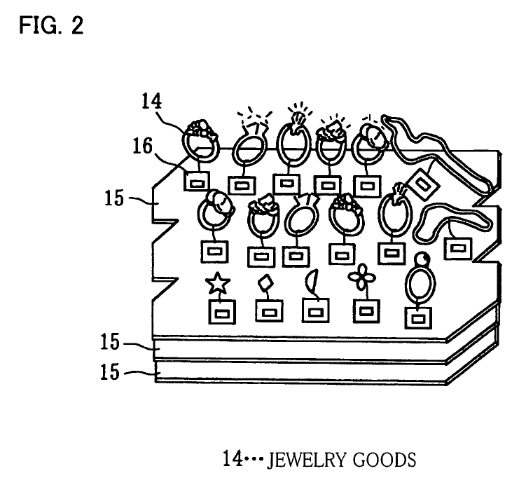

In the commodity case 12, a large number of jewelry goods 14 such as jewels and noble metal are aligned, in a plane manner, on plural exhibition plates 15, as illustrated in FIG. 2. To each of the various jewelry goods 14 of various commodity values, there is attached a price tag in which an RF tag (information storage medium) is included. This RF tag stores information corresponding to the associated jewelry good 14.

Further, in the stock management system of the present embodiment, the reader/writer 13 includes an antenna which generates a magnetic filed for later described contact-less communications, and the information stored in the RF tag of each jewelry good 14 in the commodity case 12 is gathered en bloc, by bringing the commodity case 12 in the magnetic-field-generated region.

As illustrated in FIG. 1, the reader/writer 13 has a rectangular plate like shape, and has a size which allows communications with the storing section of the commodity case 12. Inside this reader/writer 13, a control section (controller; not shown) and a battery (not shown) are provided.

Further, on the top face of the reader/writer 13, a loop-like antenna coil is provided around a wide region, so that the antenna 18 and the reader/writer 13 are integrally formed. This antenna 18 causes an occurrence of the magnetic-field-generated region 18 above the plane on which the antenna 17 is provided.

When the commodity case 12 is brought, from above, close to the magnetic-field-generated region 17 above the antenna 18, while a large number of the jewelry goods 14 each having the RF tag are stored in the commodity case 12, the information stored in the RF tag of each jewelry good 14 are read out en bloc in a contact-less manner, in response to the magnetic-field-generated region 17 of the antenna 18. The read out information is stored in a memory (not shown), in the control section of the reader/writer 13.

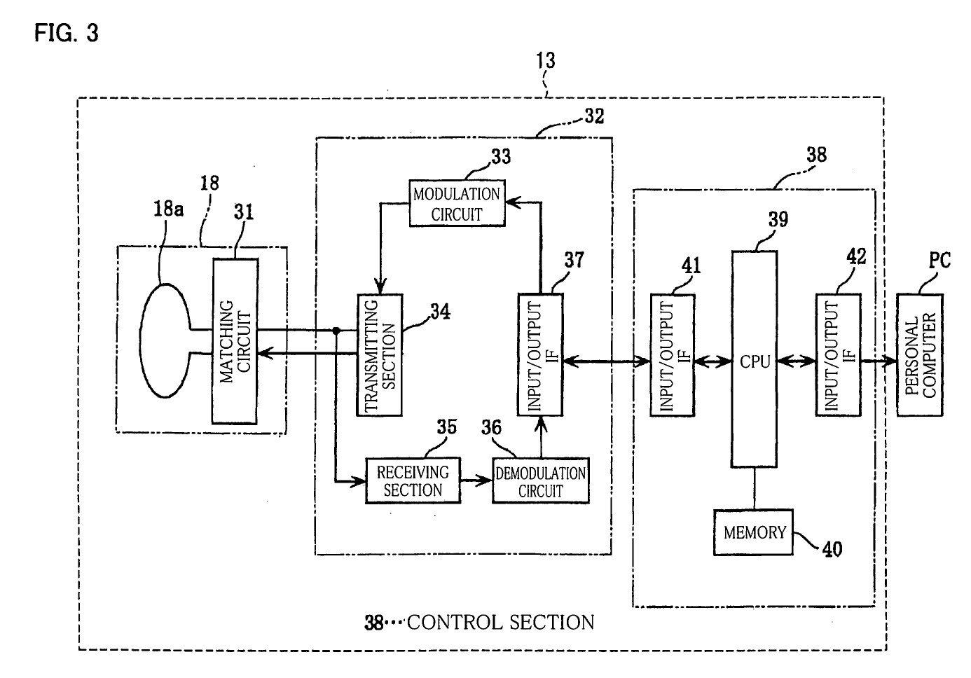

Next described, with reference to a block diagram of FIG. 3, is a specific configuration of the reader/writer 13.

As illustrated in FIG. 3, the reader/writer 13 includes: the antenna 18, an amplifier 32, and the control section (control means) 38. The antenna 18 includes an antenna coil 18a and a matching circuit 31. The antenna coil 18a is formed by an electrically conductive wire rod, and is outwardly extended so that both end portions of the antenna coil 18 are parallel to each other. Further, the antenna coil 18a is connected to the amplifier 32 via the matching circuit 31, by using a coaxial cable.

Note that if the cable between the matching circuit 31 and the antenna coil 18a is short, the matching circuit 31 may be in the side of the amplifier 32. In this case the antenna 18 is formed only by the antenna coil 18a.

The matching circuit 31 is a circuit which matches an impedance of a feeder connected to the amplifier 32 and an impedance of the antenna coil 18a, and has a configuration in which (a) two capacitance-variable capacitors are serially connected between two signal lines extended from the antenna coil 18a, and (b) a jointing portion via which both of the capacitors are connected is grounded.

The amplifier 32 includes: a modulation circuit 33; a transmitting section 34; a receiving section 35; a demodulation circuit 36; and an input/output IF (interface) 37.

The modulation circuit 33 modulates, in accordance with information or a command to be transmitted, a high frequency generated in an oscillation circuit (not shown), the information or command having been output from a CPU 39 of the control section 38. The transmitting section 34 amplifies, with a use of an amplifying circuit (not shown), a signal having been modulated in the modulation circuit 33, and drives the antenna coil 18a of the antenna 18. On the other hand, a signal having been received by the antenna 18 is input to the demodulation circuit 36 via the receiving section 35.

Then, the demodulation circuit 36 demodulates the signal having been input via the receiving section 35, and outputs a demodulated signal to the input/output IF 37 which controls transmission of signals between the control section 38 and the input/output IF 37.

The control section 38 includes the CPU 39, a memory 40, and input/output IFs 41 and 42. The CPU 38 controls a later described operation of writing or reading out information to/from the RF tag. The memory 40 stores therein, for example, (a) information or the like for use in a processing, and (b) a control program for controlling communications with the RF tag. The input/output IF 41 is for controlling signal transmission between the amplifier 32 and the input/output IF 41, and the input/output IF 42 is for controlling signal transmission between the input/output IF 42 and the personal computer PC.

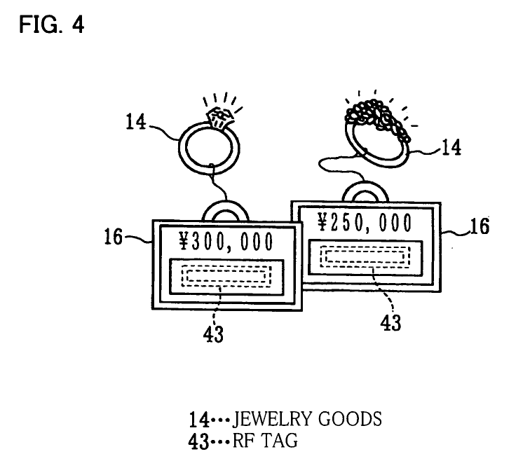

FIG. 4 illustrates an exemplary situation where the jewelry goods 14 are marketed with a price tag 16 being attached to each of them, the price tag 16 having the RF tag 43 configured by an antenna coil and an IC. When the commodity case 12 is brought above the reader/writer 13, each of the jewelry goods 14 having such price tag is in the magnetic-field-generated region 17 which is created by the antenna 18. As such, the information in the RF tag integrated with the price tag of each jewelry goods 14 is read out in a contact-less manner by the reader/writer 13.

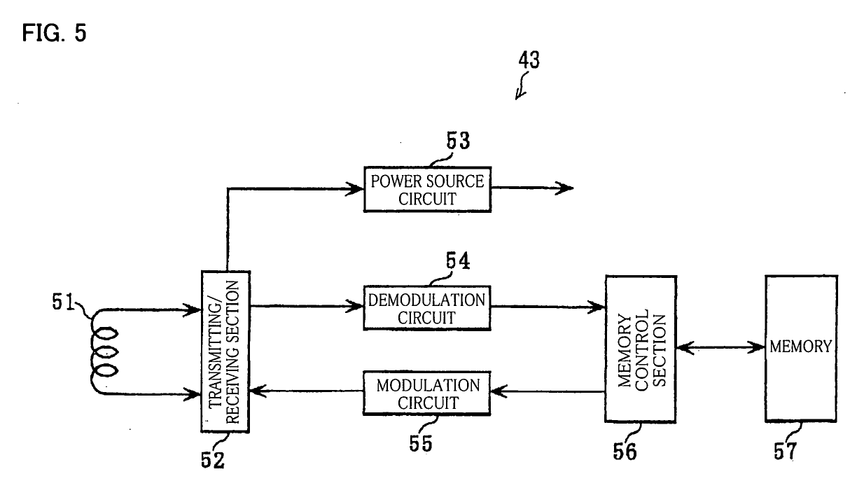

FIG. 5 is a block diagram illustrating the RF tag 43 in each of the price tags 16 attached to the jewelry goods 14. The RF tag 43 includes: an antenna coil 51; a transmitting/receiving section 52; a power source circuit 53; a demodulation circuit 54; a modulation circuit 55; a memory control section 56; and a memory 57.

When the RF tag 43 is in the magnetic-field-generated region 17 of the reader/writer 13, a signal received via the antenna coil 51 is output to the power source circuit 53 via the transmitting/receiving section 52, so that power for driving each section of the device is provided. Further, the signal received from the reader/writer 13 via the antenna coil 51 is output to the demodulation circuit 54 via the transmitting/receiving section 52, and a demodulated signal is transmitted to the memory control section 56.

The memory control section 56 is connected to the memory 57 via a bus. This memory control section 56 reads out or writes information to/from the memory 57, in accordance with a command or information given by the control section 38. The information having been read out from the memory 57 is transmitted to the transmitting/receiving section 52 via the modulation circuit 55, and drives the antenna coil 51.

Communications with the reader/writer 13 using a load switching method is performed as follows. Namely, a modulation circuit, which includes serially-connected a resistor and a switching element such as an FET, is connected in parallel to the antenna coil 51, and the information stored in the RF tag 43 is transmitted to the side of the reader/writer 13 by varying the load of the antenna coil with the use of the switching element.

Next described is how a stock management operation is performed in a case where the salesperson 11 conducts, with the use of the commodity case 12, a sales activity outside his/her shop. When the salesperson 11 conducts a sales activity, the plural exhibition plates 15 having thereon a large number of jewelry goods 14 are set in the commodity case 12 (See FIG. 2). After the jewelry goods 14 for sale are stored, the commodity case 12 is placed within the magnetic-field-generated region 17 which is output above the reader/writer 13 (See FIG. 1), so that the information in the RF tag 43 of each of the jewelry goods 14 is read out en block and in a contact-less manner, by the reader/writer 13. Thus, an operation of gathering and managing stock information of all the jewelry goods 14 in the commodity case 12 is instantaneously completed.

Particularly in this case, the stock information of all the jewelry goods 14 in the commodity case 12 is read out en bloc, for each commodity case 12. This saves labor of the salesperson 11 or a specialized clerk, and enables an efficient stock management. Further, at the time of taking the jewelry goods 14 outside the shop, the operation of reading out the stock information of all the jewelry goods 14 is easily completed, without a need of opening the mobile commodity case 12. Further, the stock information read out prior to the sales activity is gathered in the personal computer PC, via the reader/writer 13, and is managed in the personal computer PC.

After reading out the RF tag 43 attached to each of the jewelry goods 14 in the commodity case 12 prior to the sales activity, the salesperson 11 is able to promptly take the commodity case 12 with him/her, and start his/her sales activity.

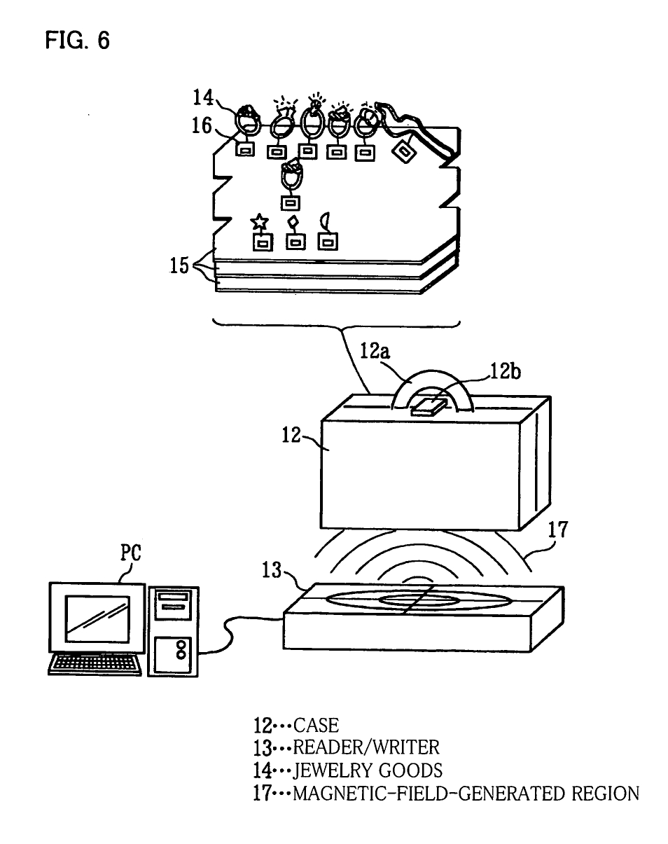

After the salesperson 11 returns to the shop from his/her sales activity, an after-sales stock management of the jewelry goods 14 in the commodity case 12 is performed as follows. Namely, as illustrated in FIG. 6, the commodity case 12 is held above the reader/writer 13 within the magnetic-field-generated region 17, so that the stock information is gathered en bloc, by reading out in a contact-less manner the information in the RF tag 43 integrated with the price tag 16 of each jewelry good 14 remaining in the commodity case 12. The read out stock information is stored in the memory 40 of the read/writer 13. Then, the stock information is transmitted to the personal computer PC connected to the reader/writer 13, and is stored and managed in the personal computer PC.

Here, a difference in the number of jewelry goods 14 in the commodity case 12 before and after the sales activity is the number of the jewelry goods 14 having been sold, and the number of the jewelry goods 14 remaining in the commodity case 12 is managed as the stock information. Further, it is possible to realize a delicate and accurate stock management, based on the information of each commodity case 12, which information is gathered by the personal computer PC.

For example, it is possible to find out, from the stock information, which one of the sold jewelry goods 14 is popular. Based on the finding, the popular jewelry goods 14 can be stocked up in preference to the other goods. Further, it is possible to develop new commodities which resemble to the popular jewelry goods 14. On the other hand, a commodity management can be carried out so as not stock an unpopular jewelry good 14 which remains being stocked.

### Embodiment 2

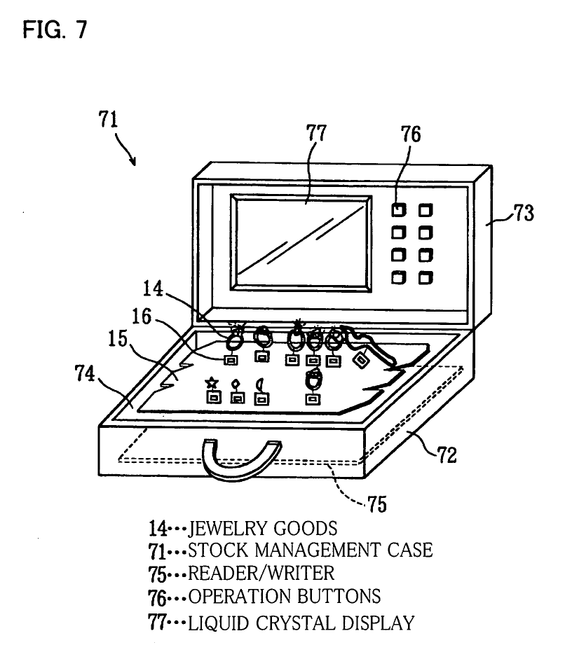

The following describes another embodiment of the present invention. FIG. 7 illustrates a mobile commodity case 71 which is capable of independently performing and completing a stock management. This mobile commodity case 71 has an open/close configuration such that a case cover 73 opens or closes in relation to a case main body 72. Inside the case main body 72, there is provided a storing section (storing means) 74 for storing therein plural exhibition plates 15 on which jewelry goods 14 are placed.

Further, a reader/writer 75 is laid, in a plane manner, on a surface at the bottom of this storing section 74. From an antenna (not shown) of the reader/writer 75 throughout the entire storing region of the storing section 74, a magnetic field is generated for performing contact-less communications with an RF tag in price tag 16 of each of the jewelry goods 14 in the region where the magnetic field is generated by the antenna. Then, information in the RF tag within the magnetic-field-generated region are gathered en bloc by the control means (not shown) of the reader/writer 75. The reader/writer 75 then stores the gathered information in a memory (not shown) of the reader/writer 75.

Meanwhile, the case cover 73 is provided therein with: a plurality of control buttons (input means) 76 and a liquid crystal display (information presenting means, output means) 77. The plural control buttons 76 includes various buttons such as: a power source button, contact-less communications starting/ending button for use in a stock management, a display button, and the like, so that the salesperson 11 is able to, at any time, carry out an input operation to: (A) instantaneously gather the stock information of the jewelry goods 14 in the mobile commodity case 71; and (B) cause the control section of the mobile commodity case 71 to store and manage the gathered stock information.

Further, the liquid crystal display 77 is capable of displaying the gathered stock information of the jewelry goods 14. Instead of the liquid crystal display 77, it is possible to adopt a speaker so that the stock information can be obtained by means of audio assistance.

The above described configuration of the mobile commodity case 71 includes the reader/writer 75 which uses the storing section 74 as a communications region. The reader/writer 75, therefore, is able to communicate with the RF tags of all jewelry goods 14 contained in the case 71. Thus, it is only the mobile commodity case 71 which is needed for managing the stock information of all the jewelry goods 14 in the mobile commodity case 71.

Furthermore, it is possible to store, in a memory, the stock information of the jewelry goods 14 having been gathered via a communication. Then, the memory can be connected to a calculator of a personal computer or the like for the purpose of managing the information stored in the memory.

As described, a commodity management system of the present invention includes: a mobile commodity case for storing a plurality of commodities each having information storage medium which is writable and readable so that writing and reading out of information in a contact-less manner are possible between a reader/writer and the information storage medium; and control means for collecting en bloc information of all the commodities stored in the mobile commodity case, via contact-less communications performed between the information storage mediums and the reader/writer.

The configuration allows commodity stock management to be performed efficiently in a short time.

Further, a mobile commodity case of the present invention includes: a reader/writer; storing means for storing a plurality of commodities each having information storage medium which is writable and readable so that writing and reading out of information in a contact-less manner are possible between a reader/writer and the information storage medium; and control means for performing contact-less communications between the reader/writer and the information storage medium, so as to collect en bloc information of all the commodities stored in the storing means.

In the above configuration, the information of the commodities in stored in the storing means is gathered en bloc by using the reader/writer. Therefore, it is possible to accurately manage the information regarding commodities with the use of the mobile commodity case only.

Further, it is preferable that the mobile commodity case further include input means for supplying control instruction of said contact-less communication.

The configuration allows a user to instantaneously manage the stock of the commodities in the mobile commodity case, at any time (e.g. before/after sales activity, at the time of selling the commodity), simply by using the input means.

Further, it is preferable that the mobile commodity case having the above configuration further include information presenting means for presenting, to a user, the information of the commodities stored in the storing means.

In the configuration, it is possible to present the information regarding the commodities in the mobile commodity case to the user, with the use of the information presenting means such as a liquid crystal display. In addition, by adopting a speaker, the information of the commodities can be also presented to the user by an audio guidance.

The present invention can be also expressed as follows.

Namely, the present invention is a commodity management system, including: a mobile case for storing a plurality of commodities each having an RF tag for storing information, which tag allows for reading and writing of information in a contact-less manner, wherein when said case is brought close to a reader/writer having an antenna for generating a magnetic field for contact-less communications, the information in the RF tag of each of the commodities stored in the case are collected en bloc, based on a magnetic field generating function of the reader/writer.

In the configuration, the RF tags respectively attached to a large number of commodities stored in the mobile case are read en bloc and in a contact-less manner, by using the reader/writer. As such, with the configuration, information of all the commodities is read out en bloc by bringing the case in the communications region of the reader/writer. Thus, for each case, the information of all the commodities stored is read out at once. This is unburdens the user, and allows efficient stock management to be performed in a short time.

For example, in a case of a sales activity, where commodities in a shop is taken out from the shop, an operation of reading out the information of all the commodities is completed simply by bringing the case close to the communications region of the reader/writer, and there is no need for opening the mobile case before and after the sales activity.

By storing, in a personal computer or the like, the information having been read out by the reader/writer, it is possible to realize a delicate and accurate stock management based on the information stored in the personal computer. Then, it is possible to find out, from the stock information, which one of the sold commodities is popular. Based on the finding, the popular commodities can be stocked up in preference to the other goods. Further, it is possible to develop new commodities which resemble to the popular commodities. On the other hand, a commodity management can be carried out so as not stock an unpopular commodity which remains being stocked.

Further, the present invention may be expressed as a mobile commodity case in which (i) a magnetic-field-generated region is generated on an antenna of a reader/writer, (ii) the magnetic-field-generated region is associated with RF tags, each of which is attached to a commodity and stores therein unique information, so as to generate an electric power on an antenna of each of the RF tag, (iii) a control circuit of each of the RF tag is driven by the electric power so that the RF tag transmits its information to the reader/writer, and (iv) the reader/writer gathers, in a contact-less manner, the information of the RF tag, based on the transmission, said mobile commodity case including: a storing section for storing a plurality of commodities respectively having said RF tags; an antenna for generating a magnetic field throughout an entire storing region of the storing section; and a control section for gathering en bloc, upon start of contact-less communications with the RF tags in the magnetic-field-generated region generated on the antenna, the information of all the RF tags within the magnetic-field-generated region.

In the configuration, the mobile stock management case is provided with the antenna of the reader/writer which uses the entire storing section as the communication region. Accordingly, with the stock management case, communications with RF tags of all the commodities stored in the case is possible. Further, the stock information of the commodities gathered via the communications can be stored in the memory.

Thus, it is possible to accurately manage the stock information regarding the commodities stored, with the use of the stock management case only. Furthermore, an information processing device such as a personal computer may be connected, so that the gathered information is presented to the user via the monitor or other output means.

Further, the mobile commodity case may further include: input means for causing starting of the contact-less communications with the RF tag within the magnetic-field-generated region generated on the antenna.

The configuration allows the stock of the commodities in the mobile commodity case can be instantaneously managed, at any time (e.g. before/after sales activity, at the time of selling the commodity).

Further, the mobile commodity case may further include output means for outputting stock information of the commodities having been gathered in the control section.

By adopting a liquid crystal display or the like as the output means, it is possible to display the stock information of inside the stock management case. Other than that, by adopting a speaker or the like as the output means, the information can be also presented by an audio guidance.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

In a case of a sales activity where commodities in a shop are taken out from the shop, the present invention allows stocks to be easily managed by reading out en bloc and in a contact-less manner, information of all the commodities in a mobile commodity case before and after the sales activity. This saves labor and time of a sales person, and reduces burden in a stock management work. The present invention is particularly suitable for a case where frequent stock management is necessary, as is the case of marketing expensive commodities such as jewelry goods.

1-8. (canceled)

9. A mobile commodity case for storing a plurality of commodities, comprising:
a storing section for storing a plurality of detachable plates on which said commodities respectively having RF tags are placed;
input means for allowing an input operation to be performed;
a reader/writer for performing, based on the input operation, contact-less communications with the RF tags on the plurality of the plates; and
a display for displaying information of all the RF tags of the commodities, which information having been gathered en bloc via the communications, wherein
an antenna of said reader/writer is arranged so as to be in parallel to the plates stored, and
said reader/writer is provided on a surface at a bottom of said storing section so that the entire storing section is a communications region.

10. The mobile commodity case as set forth in claim 9, wherein:
said storing section is provided on a side of a case main body;
the side of the case main body is provided with an open/close structure so that opening/closing of a case cover is enabled, the case cover being one side of the mobile commodity case; and
said input means and said display are provided on an internal surface of the case cover.

11. The mobile commodity case as set forth in claim 9, wherein a grip for disposing the mobile commodity case is externally provided.

12. The mobile commodity case as set forth in claim 10, wherein a grip for disposing the mobile commodity case is externally provided.
